(19) United States
(12) Patent Application Publication
(10) Pub. No.: US 2012/0137624 A1
(43) Pub. Date: Jun. 7, 2012

(54) WINDOW FRAME FOR DOOR USING HOLDER PIN

(75) Inventor: Peter Yong SIBBETT, Tacoma, WA (US)

(73) Assignee: CAPSTONE ENGINEERING CO., LTD., Changnyeong-Gun (KR)

(21) Appl. No.: 13/087,718

(22) Filed: Apr. 15, 2011

(30) Foreign Application Priority Data
Dec. 6, 2010 (KR) 2010-0123289

(51) Int. Cl. E04C 2/38; E06B 3/96

(52) U.S. Cl. 52/656.5; 52/656.9

(57) ABSTRACT

Disclosed is a window frame for a door using a holder pin having a novel structure in which an exposed part caused by a screw does not exist, the coupling work can be simply achieved, frame bodies are manufactured by using a single mold, and the frame bodies can be coupled with each other at interior and exterior sides. The window frame includes two frame bodies having a form of a frame coupled with a window, installed in an opening of a body frame, and coupled with each other at interior and exterior sides about the opening while facing each other, protruding boss parts protruding from facing positions of the two frame bodies and having coupling holes recessed in an axial direction from an end surface thereof, and a holder pin having two opposite ends.

### CROSS REFERENCE TO RELATED APPLICATIONS

This application claims the benefit and priority of Korean Patent Application No. 2010-0123289 filed Dec. 6, 2010. The entire disclosure of the above application is incorporated herein by reference.

### BACKGROUND OF THE INVENTION

1. Field of the Invention

The present invention relates to a door. More particularly, the present invention relates to a door having a window in which a window frame structure fixedly couples the window to a door body.

2. Description of the Related Art

In general, a door includes a body frame having an opening used to install a window and a window frame fixedly coupling the window to the opening.

The window frame includes an interior window frame, which is positioned at an inner side about a window provided in the opening of the body frame and coupled with the opening, and an exterior window frame which is positioned at an outer side about the window and coupled with the opening.

The two window frames include various materials such as wood, metal, or synthetic resin, and are coupled with each other through various coupling schemes such as a screw coupling scheme or a hook coupling scheme.

If the two window frames are coupled with each other through the hook coupling scheme, the two window frames may be exactly coupled with each other due to the thickness error of the body frame.

In addition, the hook may be easily broken due to the shock occurring in a weaker direction. If the hook is broken, the two window frames are spaced apart from each other or offset from each other at a broken portion of the hook.

Accordingly, conventionally, the two window frames are coupled with each other through the combination of the hook coupling scheme and the screw coupling scheme.

However, the screw coupling scheme requires longer working time than that of the hook coupling scheme, so that the productivity may be degraded.

In order to perform the screw coupling scheme, one of the two window frames is provided therein with a screw coupling hole, and the other is provided therein with a boss to be coupled with a screw. In general, the screw coupling hole is formed in the interior window frame, and the boss is formed in the exterior window frame.

However, the interior window frame and the exterior window frame are manufactured by using molds different from each other due to the structure difference between the screw coupling hole and the boss. Accordingly, two types of molds must be provided to manufacture the window frame.

In addition, since the interior window frame and the exterior window frame have different shapes, the interior and exterior window frames must be separately stored.

In addition, the screw coupling hole serves as a weak point of a related window frame. Accordingly, if impact occurs in the related point, the window frame may be easily broken. Therefore, the window frame shows a low pass rate in a performance test such as an impact test.

In addition, since the screw coupling hole degrades the esthetic sense in terms of the design of the window frame, an additional cover (plug) is generally provided and subject to a finish work to prevent the screw coupling hole from being exposed to the outside in the interior.

The finish work to process the cover increases the number of the assembling processes, so that the manufacturing time may be more increased.

### SUMMARY OF THE INVENTION

Accordingly, the present invention has been made to solve the above-mentioned problems occurring in the prior art, and an object of the present invention provides a window frame having a novel structure in which an exposed part caused by a screw does not exist, the coupling work can be simply achieved, frame bodies are manufactured by using a single mold, and the frame bodies can be coupled with each other at interior and exterior sides.

According to the embodiment, a window frame for a door using a holder pin includes two frame bodies having a form of a frame coupled with a window through the combination of a plurality of horizontal frames and a plurality of vertical frames, installed in an opening of a body frame constituting a door, and coupled with each other at interior and exterior sides about the opening while facing each other, protruding boss parts protruding from facing positions of facing surfaces of the two frame bodies and having coupling holes recessed in an axial direction from an end surface thereof, and a holder pin having two opposite ends which are inserted into two facing coupling holes of the two protruding boss parts and have a plurality of wedges protruding circumferential surfaces thereof.

In this case, a step part protrudes from a central portion of the holder pin and has a diameter larger than a size of the coupling hole, and a step groove is recessed in the end surface of the protruding boss part and has a depth to allow insertion of a half of the step part and a diameter wider than a diameter of the coupling hole.

In addition, wedges formed on one end and an opposite end of the holder pin have diameters gradually reduced toward a direction in which related wedges are coupled with the coupling holes of the protruding boss part.

In addition, the protruding boss part is formed on an edge of the frame body.

In addition, a plurality of locking hooks protrude from facing surfaces of the two frame bodies.

In addition, the locking hooks have shapes identical to each other, the locking hooks formed on the upper most portion of the frame body are asymmetry to the locking hooks formed on the lower most portion of the frame body with respect to a central axis of the frame body extending in a horizontal direction, and the locking hooks formed on the leftist portion of the frame body are asymmetry to the locking hooks formed on the rightist portion of the frame body with respect to a central axis of the frame body extending in a vertical direction.

### ADVANTAGEOUS EFFECTS

As described above, in the window frame for the door according to the present invention, two frame bodies closely make contact with each other by using holder pins, so that the two frame bodies can be firmly coupled with each other. Accordingly, a screw work can be omitted.

In particular, since the holder pins are inserted into protruding boss parts formed on the two frame bodies, any parts are not exposed to the outside. Accordingly, an additional work to cover exposed parts is not required.

In addition, since two frame bodies have the same shape, the manufacturing cost of a mold can be reduced. In addition, since the frame bodies can be stored in the form of a single product, the storage cost can be reduced.

In addition, the window frame for the door using the holder pin according to the present invention includes a locking hook, so that the two frame bodies can be firmly coupled with each other through an opening.

### BRIEF DESCRIPTION OF THE DRAWINGS

FIG. 1 is an exploded perspective view showing a window frame for a door using a holder pin according to an exemplary embodiment of the present invention;

FIG. 2 is a front view showing the window frame for the door using the holder pin according to the exemplary embodiment of the present invention;

FIG. 3 is a side view showing the window frame for the door using the holder pin according to the exemplary embodiment of the present invention;

FIG. 4 is a plan view showing the window frame for the door using the holder pin according to the exemplary embodiment of the present invention;

FIG. 5 is a perspective view showing main components of the window frame for the door using the holder pin according to the exemplary embodiment of the present invention; and

FIGS. 6 to 8 are enlarged views showing the coupling state of holder pins and protruding boss parts in the window frame for the door using the holder pin according to the exemplary embodiment of the present invention.

### DETAILED DESCRIPTION OF THE EXEMPLARY EMBODIMENTS

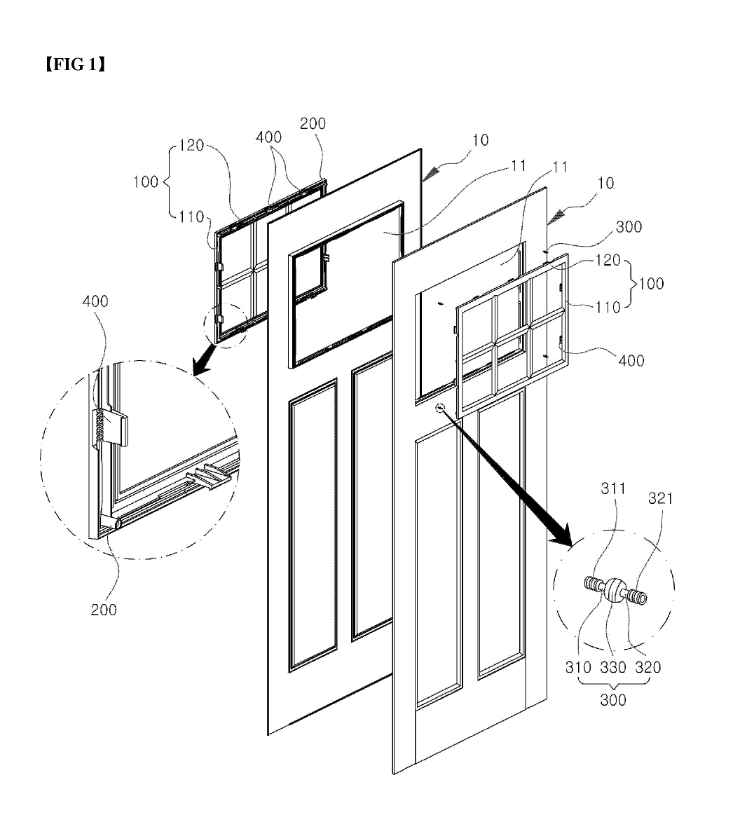

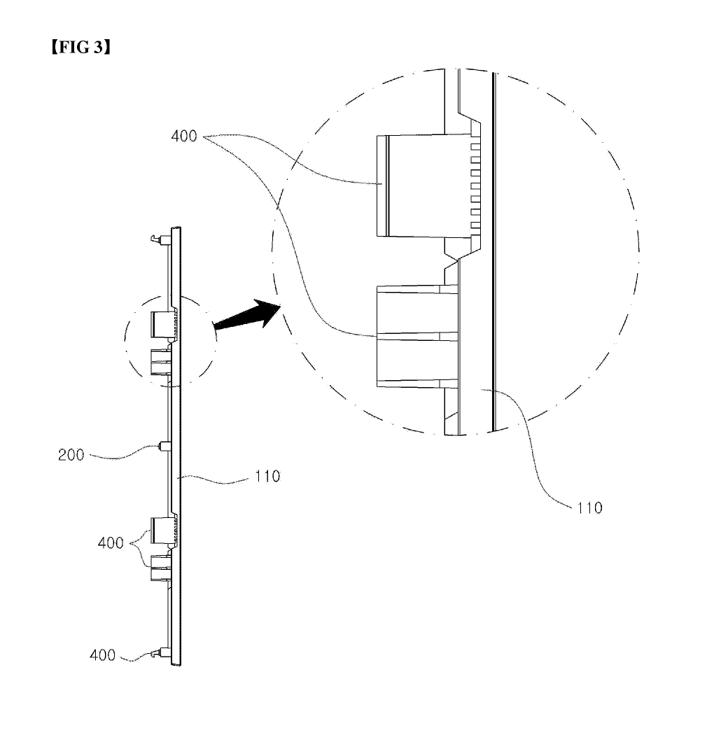

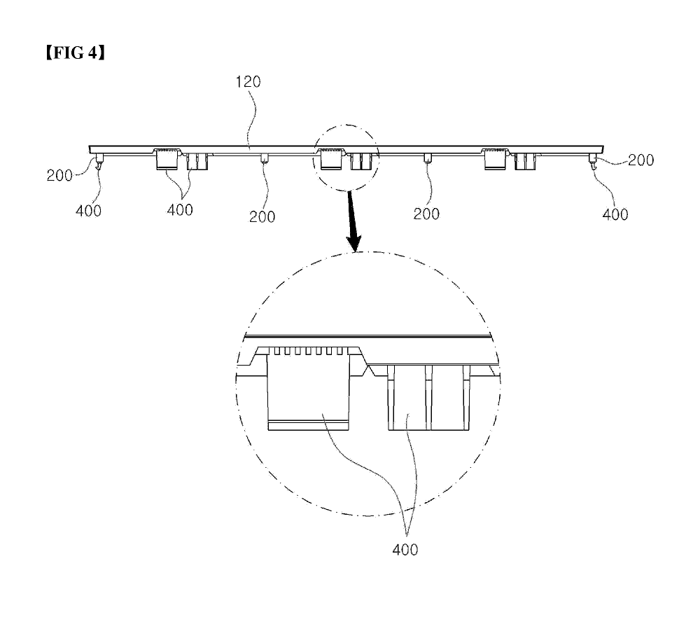

Hereinafter, a window frame for a door using a holder pin according to an exemplary embodiment of the present invention will be described with reference to FIGS. 1 to 8.

As shown in FIGS. 1 to 5, the window frame for the door using the holder pin according to the embodiment of the present invention includes two frame bodies 100, a protruding boss part 200, and a holder pin 300.

Hereinafter, the present invention will be described in more detail while focusing on the components.

The two frame bodies 100 constitute a body of the window frame for the door using the holder pin.

As shown in FIG. 1, the frame body 100 is installed in an opening 11 of a body frame 10 of the door. Two frame bodies 100 are paired and coupled with each other while facing each other in the state that the fame bodies 100 are provided at inner and outer sides about the opening 11 of the body frame 10.

In addition, the two frame bodies 100 have the form of a frame between which a window 20 is coupled.

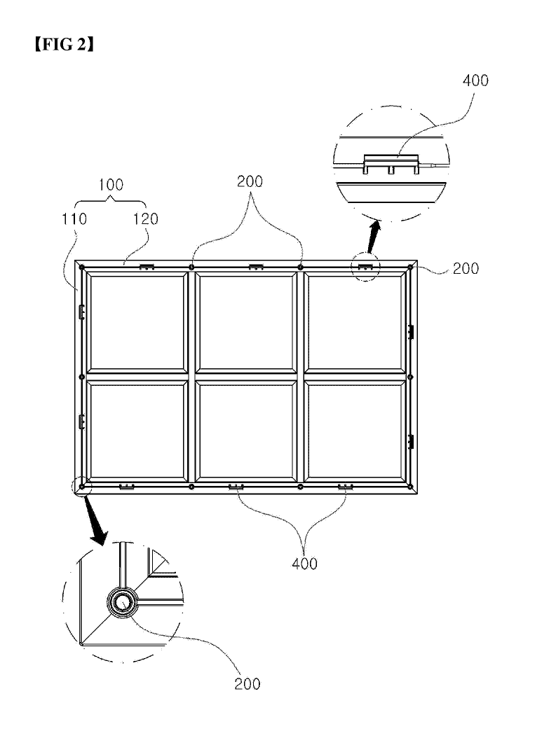

Although the embodiment of the present invention suggests that the frame bodies 100 have the shape of a rectangular frame formed by combining a plurality of vertical frames 110 with a plurality of horizontal frames 120 as shown in FIGS. 1 and 2, the frame bodies 100 may have a circular shape or a polygonal shape if necessary.

The protruding boss part 200 is coupled with the holder pin 300 to be described later.

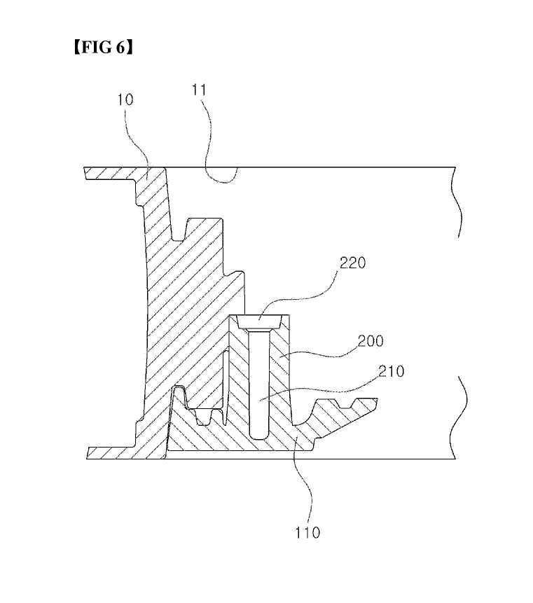

The protruding boss part 200 protrudes from facing surfaces of the two frame bodies 100, and a coupling hole 210 (see FIGS. 6 to 8) is recessed in an axial direction of the protruding boss part 200 from an end of the protruding boss part 200.

In particular, according to the embodiment of the present invention, protruding boss parts 200 are provided at a plurality of portions including edges of the two frame bodies 100.

The protruding boss parts 200 formed at the edges of the two frame bodies 100 firmly couple the two frame bodies 100 to each other, so that esthetic sense can be prevented from being degraded due to the gap between the two frame bodies 100 at each edge. The protruding boss parts 200 formed at the remaining portions of the two frame bodies 100 reinforce a coupling strength between the two frame bodies 100.

The holder pin 300 couples two facing protruding boss parts 200 formed on the two frame bodies 100 to each other.

In particular, according to the embodiment of the present invention, the holder pin 300 is configured to be inserted into the two frame bodies 100 while facing the two frame bodies 100 in opposition to each other.

In other words, since the holder pin 300 is not coupled with the protruding boss part of one frame body 100 by passing through the other frame body 100, a part of the holder pin 300 is not exposed to the outside. Therefore, the esthetic sense of the outer appearance is prevented from being degraded, and an unnecessary work such as the installation of plug to cover the exposed part can be omitted.

As shown in FIG. 1 and FIGS. 6 to 8, the holder pin 300 has one end 310 and an opposite end 320 inserted into coupling holes 210 of the two protruding boss parts 200 positioned in opposition to each other. A plurality of wedges 311 and 321 protrude from outer peripheral surfaces of the one end 310 and the opposite end 320.

The diameters of the wedges 311 are gradually reduced toward the distal end the one end 310 and the diameters of the wedges 321 are gradually reduced toward the distal end of the opposite end 320.

In other words, when the one end 310 or the opposite end 320 of the holder pin 300 is coupled with the coupling hole 210 of the related boss part 200, the one end 310 or the opposite end 320 of the holder pin 300 is smoothly inserted into the coupling hole 210 due to the inclination direction of the wedges 311 and 321. After the one end 310 or the opposite end 320 of the holder pin 300 has been completely coupled with the coupling hole 210, the one end 310 or the opposite end 320 does not move in a direction opposite to the inclination direction of the wedges 311 and 321.

A step part 330 protrudes from the central portion of the holder pin 300 and has a diameter larger than the size of the coupling hole 210 of the protruding boss part 200. As shown in FIGS. 6 to 8, the protruding boss part 200 has a step groove 220 recessed in the end surface thereof, in which the step groove 220 has a depth to allow the insertion of a half of the step part 300 and a diameter wider than that of the coupling hole 210.

Accordingly, the holder pin 300 is completely inserted into the two protruding boss parts 200, so that the two protruding boss parts 200 completely makes contact with each other.

Meanwhile, the embodiment of the present invention additionally suggests locking hooks 400 formed on the facing surfaces of the two frame bodies 100 in the window frame for the door using the holder pin described above.

The locking hooks 400 more stably couples the frame body 100 to the opening 11 formed in the body frame 10 of the door. In other words, the protruding boss parts 200 and the wedges 311 and 312 only couples the two frame bodies 100 to each other. Accordingly, since the two frame bodies 100 does not completely make contact with the body frame 10, movement may partially occur. Therefore, the locking hook 400 is additionally provided to prevent the frame bodies 100 from moving.

The locking hook 400 includes a protrusion part 410 protruding outward (the same direction as that of the protruding boss part) from a rear surface of the frame body 100 and a locking part 420 curved at the end of the protrusion part 410 to grip the body frame 10.

Preferably, a plurality of locking hooks 400 are provided, and interposed between the protrusion boss parts 200 on the rear surface of the frame body 100.

In particular, according to the embodiment of the present invention, the locking hooks 400 positioned on the upper most horizontal frame 120 of the frame body 100 are asymmetric to the locking hooks 400 positioned on the lower most horizontal frame 120 of the frame body with respect to the central axis of the frame body 100 extending in a horizontal direction. The locking hooks 400 formed on the upper most horizontal frame 120 are positioned at the left side or the right side of the locking hooks 400 formed on the lower most horizontal frame 120.

In addition, the locking hooks 400 formed on the leftist side vertical frame 110 are asymmetry to the locking hooks 400 formed on the rightist side vertical frame 100 with respect to the central axis of the frame body 100 extending in the vertical direction. The locking hooks 400 formed on the leftist side vertical frame 110 are positioned at the top side or the bottom side of the locking hooks 400 formed on the rightist side vertical frame 110.

The locking hooks 400 arranged in the horizontal or vertical direction are offset from each other with respect to the central portion of the frame body 100. Accordingly, when the frame body 100 is coupled with the other frame body 100 that is reversed, the locking hooks 400 are not matched with each other. The above structure is shown in FIGS. 2 to 4.

The protruding boss parts 200 formed on the frame body 100 always maintain the same positions. In other words, except for the protruding boss parts 200 formed at the edges of the frame body 100, the protruding boss parts 200 interposed between the locking hooks 400 maintain the same position even if the frame body 100 is reversed as shown in drawings according to the embodiment.

Accordingly, after frame bodies 100 having the above structure are manufactured in one form without distinguishing between interior and exterior frame bodies, one frame body may be reversed and used. Therefore, the frame bodies 100 can be used in common, so that only one mold can be provided. As a result, the manufacturing cost can be reduced.

Hereinafter, the installation procedure of the window frame for the door using the holder pin having the above structure according to the embodiment of the present invention will be described in more detail.

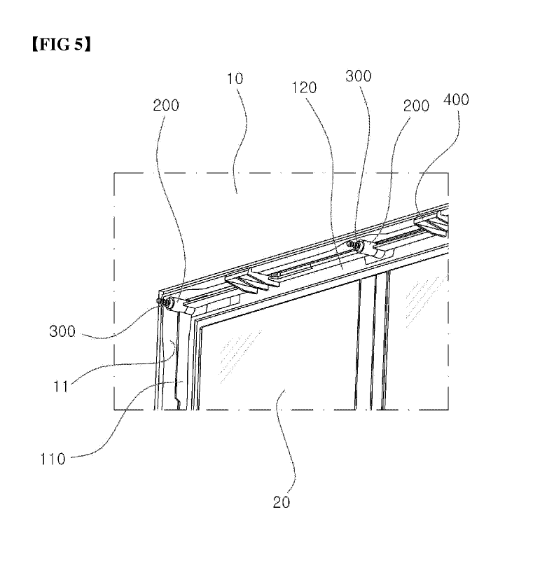

As shown in FIGS. 5 and 6, one (the first frame body) of the two frame bodies 100 having the same structure is coupled with the opening 11 of the body frame 10 at one side of the body frame 10 constituting the door.

In this case, the protruding boss parts 200 formed on the first frame body 100 pass through the opening 11 to expose to an opposite side of the body frame 10. The locking hooks 400 pass through the opening 11 of the body frame 10 and are coupled with a wall surface at the opposite side of the body frame 10. Therefore, the first frame body 100 is fixedly coupled with the body frame 10 without additional grip or fixing manipulation.

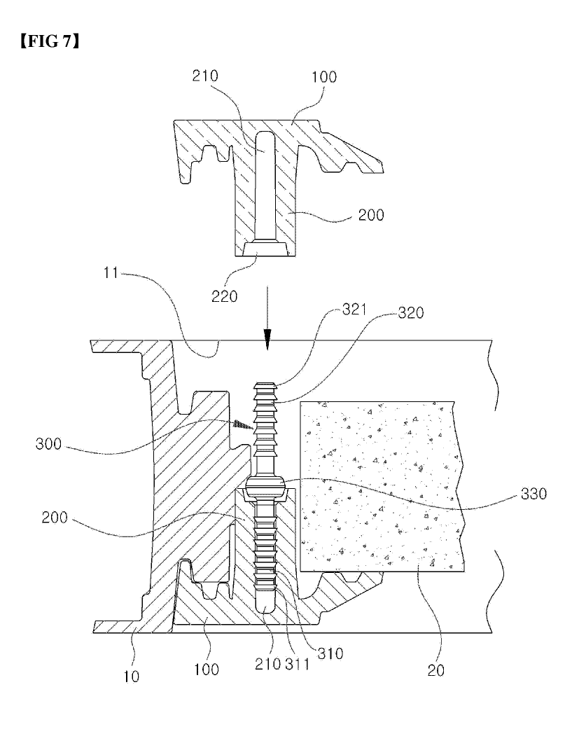

After the above work has been finished, one end 310 of the holder pin 300 is coupled with the protruding boss parts 200 of the first frame 100 as shown in FIG. 7.

In this case, the wedge 311 formed on the end 310 of the holder pin 300 maintains the locking state within the coupling hole 210 of the protruding boss part 200 and is not released out of the coupling hole 210 due to the characteristic in the shape of the wedge 311.

In the above state, the window 20 is put on the window region of the first frame body 100 and another frame body (second frame body) 100 is prepared. Thereafter, the second frame body 100 is coupled with the body frame 10 through the opening 11 at the opposite side of the body frame 10.

In this case, the locking hook parts 400 of the second frame body 100 are offset from the locking hook parts 400 of the first frame body 100 that has been already coupled with the body frame 10 of the door. This is possible by reversely providing the second frame body 100 having the same state as that of the first frame body 100.

Thereafter, if the second frame body 100 passes through the opening 11, the protruding boss parts 200 of the second frame body 100 make contact with the protruding boss parts 200 of the first frame body 100 while facing the first frame body 100. Accordingly, the opposite end 320 of the holder pin 300, which has been inserted into the protruding boss part 200 of the first frame body 100, is inserted into the coupling hole 210 formed through the protruding boss part 200, so that the two frame bodies 100 are coupled with each other.

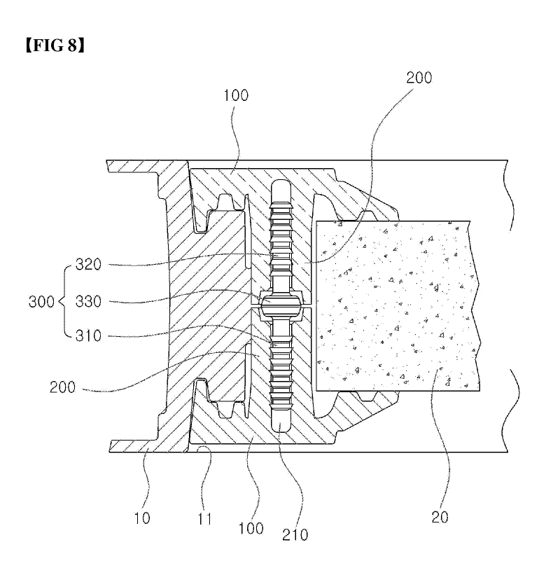

In this case, the locking hooks 400 of the second frame body 100 passes through the opening 11 of the body frame 10 in the state that the locking hooks 400 of the second frame body 100 are offset from the locking hooks 400 of the first frame body 100, and are coupled with the wall surface at one side of the body frame 10. Accordingly, as shown in FIG. 8, the window 20 is stably installed in the two frame bodies 100.

In this case, a half of the step part 330 formed at the central portion of the holder pin 300 is inserted into the step groove 220 of the protruding boss part 200 of the first frame body 100, and the other half of the step part 330 is inserted into the step groove 220 of the protruding boss part 200 of the second frame body 100. Accordingly, the holder pin 300 is not excessively inserted into the protruding boss part 200 of one of the two frame bodies 100. Therefore, the two frame bodies 100 maintain a uniform coupling state.

Therefore, in the window frame for the door using the holder pin according to the embodiment of the present invention, two frame bodies 100 are coupled with each other while closely making contact to each other without an additional screw coupling work. In addition, the two frame bodies 100 are firmly fixed to the body frame 10 of the door by the locking hook parts 400 thereof. The window 20 interposed between the two frame bodies 100 can maintain a stable installation state.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A window frame for a door using a holder pin, the window frame comprising:
two frame bodies having a form of a frame coupled with a window, installed in an opening of a body frame constituting a door, and coupled with each other at interior and exterior sides about the opening while facing each other;
protruding boss parts protruding from facing positions of facing surfaces of the two frame bodies and having coupling holes recessed in an axial direction from an end surface thereof; and
a holder pin having two opposite ends which are inserted into two facing coupling holes of the two protruding boss parts and have a plurality of wedges protruding circumferential surfaces thereof.

2. The window frame of claim 1, wherein a step part protrudes from a central portion of the holder pin and has a diameter larger than a size of the coupling hole, and
a step groove is recessed in the end surface of the protruding boss part and has a depth to allow insertion of a half of the step part and a diameter wider than a diameter of the coupling hole.

3. The window frame of claim 2, wherein the wedges are formed on one end and an opposite end of the holder pin have a diameter gradually reduced toward distal portions of the one end and the opposite end.

4. The window frame of claim 1, wherein the protruding boss part is formed on an edge of the frame body.

5. The window frame of one of claims 1 to 4, further comprising a plurality of locking hooks protruding from facing surfaces of the two frame bodies.

6. The window frame of claim 5, wherein the locking hooks have shapes identical to each other, the locking hooks formed on an upper portion of the frame body are asymmetry to the locking hooks formed on a lower portion of the frame body with respect to a central axis of the frame body extending in a horizontal direction, and the locking hooks formed on a left portion of the frame body are asymmetry to the locking hooks formed on a right portion of the frame body with respect to a central axis of the frame body extending in a vertical direction.
